(19) United States
(12) Patent Application Publication
(10) Pub. No.: US 2025/0104372 A1
(43) Pub. Date: Mar. 27, 2025

(54) VISUAL GUIDANCE METHOD FOR USER PLACEMENT IN AVATAR-MEDIATED TELEPRESENCE ENVIRONMENT AND THE SYSTEM THEREOF

(71) Applicant: KOREA ADVANCED INSTITUTE OF SCIENCE AND TECHNOLOGY, Daejeon (KR)

(72) Inventors: Sung-Hee LEE, Daejeon (KR); Dongseok YANG, Daejeon (KR); Jiho KANG, Daejeon (KR); Taehei KIM, Daejeon (KR)

(21) Appl. No.: 18/607,585

(22) Filed: Mar. 18, 2024

(30) Foreign Application Priority Data
Sep. 27, 2023 (KR) 10-2023-0130986

(51) Int. Cl. G06T 19/20

(52) U.S. Cl. CPC G06T 19/20; G06T 2219/2004

(57) ABSTRACT

Provided is a visual guidance method and system for user placement in an avatar-mediated telepresence environment that may enhance the quality of avatar placement by recommending a placement for preserving a user's interaction context and the visual guidance method includes specifying an interaction target in a space in a telepresence environment for an interaction between a local space and a remote space; computing a recommendation score for a placement of a local avatar as a maximum interaction feature similarity obtainable with the remote space based on the interaction target; visualizing the recommendation score; and placing the local avatar at an optimal placement in the remote space according to a position of a local user.

### CROSS-REFERENCE TO RELATED APPLICATION(S)

This application claims the priority benefit of Korean Patent Application No. 10-2023-0130986, filed on Sep. 27, 2023, in the Korean Intellectual Property Office, the disclosure of which is incorporated herein by reference.

### BACKGROUND

### 1. Field of the Invention

Example embodiments of the following description relate to a visual guidance method for user placement in an avatar-mediated telepresence environment and a system thereof, and more particularly, to technology for enhancing the quality of avatar placement by recommending a placement that preserves a user's interaction context.

### 2. Description of the Related Art

Rapid advances in technology gradually realize immersive mixed-reality (MR) telepresence between distance spaces. To realize a smooth interaction between people in remote spaces, various telepresence approaches are developed based on virtual reality (VR) and mixed reality (MR). Among them, avatar-mediated MR telepresence has a prominent advantage that allows a user to interact with a physical object in a local space, while communicating with a remote space user through a virtual avatar.

As two physical spaces involved in telepresence may significantly differ in terms of a shape and a layout, a remote avatar needs to move adaptively to match a remote space's shape and object to correctly convey a meaning of a user motion captured in a local space. However, creating an adaptive motion for an avatar is a highly challenging task. Initially, it is difficult to accurately infer the meaning of the user motion only with observable information, such as video data, unless the user confirms a corresponding intention. Given information on the user's motion semantics, the avatar needs to be placed and animated to preserve the meaning with respect to the remote space; the diversity of size, shape, and object layout of real spaces makes this issue more complex.

A straightforward way to avoid this challenge may be to restrict the user to be placed where a direct copy of the user's placement and motion into the avatar allows a seamless interaction between remote users. To this end, the existing arts have developed methods to find an empty area that may be shared by two spaces. However, this approach excludes an area occupied by an object from a telepresence area, reducing the size of available space for interaction.

An approach to alleviate this limitation is to allow the user to utilize the entire space and place the user's remote avatar at a position that best preserves the meaning of the user's placement. Specifically, emphasis is put on preserving a local user's interaction context for avatar placement.

Non-patent document includes, for example, M. Keshavarzi, A. Y. Yang, W. Ko, and L. Caldas, “Optimization and manipulation of contextual mutual spaces for multi-user virtual and augmented reality interaction,” in 2020 IEEE Conference on Virtual Reality and 3D User Interfaces (VR). IEEE, 2020, pp. 353-362.

### SUMMARY

Example embodiments provide a new practical approach to enhance the quality of avatar placement by recommending a high-quality avatar placement (position and orientation) for preserving a user's interaction context.

Example embodiments also provide a visual guidance for a better remote avatar placement in a bidirectional mixed reality (MR) telepresence environment.

However, technical subjects to be solved by the present invention are not limited to the aforementioned subjects and may be variously expanded without departing from the technical spirit and scope of the present invention.

According to an example embodiment, there is provided a visual guidance method for user placement in an avatar-mediated telepresence environment, the visual guidance method including specifying an interaction target in a space in a telepresence environment for an interaction between a local space and a remote space; computing a recommendation score for a placement of a local avatar as a maximum interaction feature similarity obtainable with the remote space based on the interaction target; visualizing the recommendation score; and placing the local avatar at an optimal placement within the remote space according to a position of a local user.

According to an example embodiment, there is provided a visual guidance system for user placement in an avatar-mediated telepresence environment, the visual guidance system including a target specification unit configured to specify an interaction target in a space in a telepresence environment for an interaction between a local space and a remote space; a processing unit configured to compute a recommendation score for a placement of a local avatar as a maximum interaction feature similarity obtainable with the remote space based on the interaction target; a visualization unit configured to visualize the recommendation score; and an avatar placement unit configured to place the local avatar at an optimal placement within the remote space according to a position of a local user.

According to some example embodiments, it is possible to enhance the quality of avatar placement by recommending a high-quality avatar placement (position and orientation) for preserving a user's interaction context.

Also, according to some example embodiments, it is possible to direct a user to an optimal placement that facilitates the clear transfer of gaze and pointing context through a remote avatar in dissimilar spaces in which a spatial relationship between the remote avatar and an interaction target may differ from that of a local user.

However, effects of the present invention are not limited to the aforementioned effects and may be variously expanded without departing from the technical spirit and scope of the present invention.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1A and 1B illustrate an example of user egocentric and room perspective views in space A and space B of a telepresence environment according to an example embodiment;

FIGS. 2A and 2B illustrate an example of a placement issue in a telepresence environment between dissimilar spaces according to an example embodiment;

FIG. 3 is a flowchart illustrating a visual guidance method for user placement in an avatar-mediated telepresence environment according to an example embodiment;

FIGS. 4A and 4B illustrate four angles between a source object and a target object according to an example embodiment;

FIGS. 5A and 5B illustrate a feature according to a placement and a distance with an interaction target according to an example embodiment;

FIGS. 6A and 6B illustrate similarity of sample placement of an avatar according to an example embodiment;

FIGS. 7A, 7B and 7C illustrate overview of a visual guidance according to an example embodiment; and

FIG. 8 is a block diagram illustrating a configuration of a visual guidance system for user placement in an avatar-mediated telepresence environment according to an example embodiment.

### DETAILED DESCRIPTION

Advantages and features of the present invention and methods to achieve the same may become clear with reference to the accompanying drawings and the following example embodiments. However, the present invention is not limited to the following example embodiments and may be embodied in various different forms. Rather, the example embodiments are provided as examples so that the present invention will be thorough and complete, and to fully inform one of ordinary skill in the art to which the present invention pertains and the present invention is defined by the scope of the claims.

The terms used herein are to describe the example embodiments and not to limit the present invention. As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, and elements.

Unless otherwise defined, all terms (including technical and scientific terms) used herein have the same meaning as commonly understood by one of ordinary skill in the art to which the present invention pertains. Also, terms, such as those defined in commonly used dictionaries, should not be interpreted in an idealized or overly formal sense unless expressly so defined herein.

Hereinafter, the example embodiments will be described in more detail with reference to the accompanying drawings. Like reference numerals refer to like elements throughout and further description related thereto is omitted.

The present invention relates to a visual guidance method and system for user placement in an avatar-mediated telepresence environment, and more particularly, to directing a user to an optimal placement that facilitates the clear transfer of gaze and pointing context through a remote avatar in dissimilar spaces in which a spatial relationship between the remote avatar and an interaction target may differ from that of a local user.

Representing a spatial relationship between a user/avatar and an interaction target with angle-based interaction features, recommendation scores of sampled local placements are assigned as maximum feature similarity with remote placements. These scores are visualized as color-coded two-dimensional (2D) sectors to inform the user of better placement for interaction with a selected target. Also, a virtual object of a remote space is overlapped with a local space for the user to better understand recommendation.

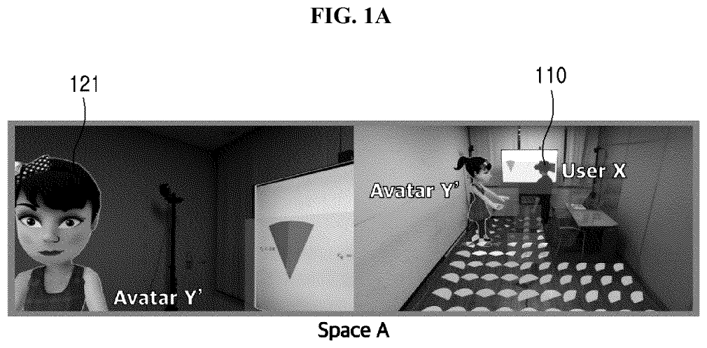

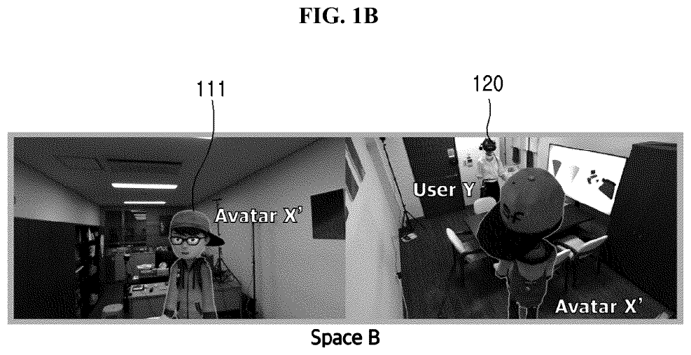

Hereinafter, example embodiments will be further described with reference to FIGS. 1 to 8.

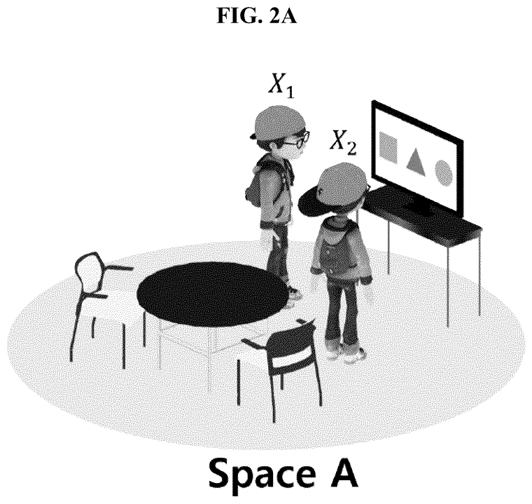

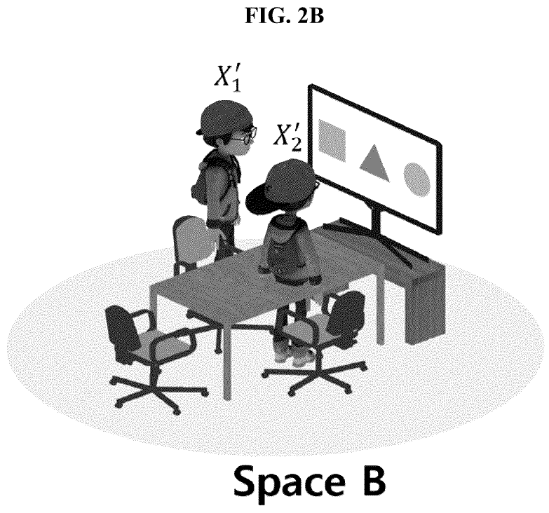

FIGS. 1A and 1B illustrate an example of user egocentric and room perspective views in space A and space B of a telepresence environment according to an example embodiment. Also, FIGS. 2A and 2B illustrate an example of a placement issue in a telepresence environment between dissimilar spaces according to an example embodiment.

In detail, FIGS. 1A and 1B illustrate user egocentric (left) and room perspective (right) views in space A and space B in a mixed reality (MR) telepresence system. Here, a user X 110 is present in space A and a user Y 120 is present in space B. A virtual avatar X′ 111 of the user X 110 appears in space B that is a remote space in which the user Y 120 is present, and a virtual avatar Y′ 121 of the user Y 120 appears in space A that is a remote space in which the user X 110 is present to represent the user X 110 and the user Y 120, respectively.

Visual guidance, color-coded sectors on the floor, and a transparent three-dimensional (3D) model of the remote space provided from a visual guidance method and system according to an example embodiment assist the user X 110 to select a placement that allows for the virtual avatar X′ 111 of the user X 110 to be appropriately placed to interact with a remote corresponding target. Therefore, after the user X 110 is located at a sector selected by the user X 110, the present invention places the virtual avatar X′ 111 at an optimal position that best corresponds to the placement of the user X 110 in space A, allowing a bidirectional interaction between the user X 110 and the user Y 120 through their avatars.

In the following, description will be made by referring to space A as a local space and space B as a remote space. Also, description will be made by referring to the user X 110 as a local user, the user Y 120 as a remote user, the virtual avatar X′ 111 as a local avatar, and the virtual avatar Y′ 121 as a remote avatar.

In detail, referring to FIG. 2A, in space A, both user placements, X₁ and _{X2}, suitably accommodate an interaction between a user and an interaction target (screen). However, referring to FIG. 2B, corresponding avatar placements that have the identical spatial relationship between an avatar and the interaction target show that X₂′ is inappropriate due to a collision with a table, making X₁ a batter placement than X₂. However, the user may not predict the quality of avatar placement according to a placement of the user without additional information. This limitation emphasizes the need for supplementary guidance to enhance the user's understanding and decision-making process regarding avatar placement in an MR telepresence scenario.

The visual guidance method and system for user placement in the avatar-mediated telepresence environment according to an example embodiment is motivated by the fact that the quality of placement of an avatar may be different for each placement of the user in a given space. For example, in FIGS. 2A and 2B, both user placements, X₁ and X₂, are appropriate for interacting with the screen (interaction target). However, X₁ allows avatar placement, X₁′, that exactly maintains the spatial relationship between the user (or avatar) and the screen while X₂ does not allow. Therefore, X₁ is more advantageous than X₂ in terms of maintaining the spatial relationship. Since the user (local user) is unable to view the remote space in which the avatar is present, it is difficult to predict the quality of avatar placement according to the placement of the user without additional information. To solve this, the present invention visualizes and presents the quality of avatar placement to the user (local user) for each candidate user placement.

In FIGS. 1A and 1B, when the user X 110 selects a desired interaction target, the present invention computes the quality of avatar placement, called a recommendation score, of a sampled local placement and visualizes scores with color-coded sectors on the floor to guide the user X 110 to select an appropriate destination to interact with a desired target (FIGS. 1A and 1B, left). Also, the present invention includes an additional presentation of a transparent virtual object (3D model) of the remote space. After the user X 110 confirms his arrival at a desired position with an input device, the present invention places the remote avatar X′ 111 in a corresponding remote placement (male avatar in FIG. 1B, right).

The approach of the present invention is thoroughly validated through two user studies in a virtual reality (VR) system that simulates telepresence situations. Also, the present invention conducts a user study in an MR telepresence scenario to validate the effectiveness of visual guidance in practice. Among various scenarios, focus is put on a remote conference of two users in a public meeting room or a private room. One-to-one preregistered correspondence is assumed between interaction targets in both spaces (e.g., screens in two spaces correspond to each other). A virtual avatar mimics a motion of its corresponding user (synchronous avatar) and only 2D position and orientation of the virtual avatar are controlled by the method presented herein. The range of interactions is narrowed to gaze and pointing gestures, which are primary non-verbal communications during a conference.

In summary, the main contributions of the present invention are as follows:
Visualization methods to guide a local user to placements of which avatar at corresponding remote placements may well preserve the user's interaction context, thereby enabling a remote user to correctly understand the local user's interaction context through the avatar's synchronous motion.
That the proposed score measure is consistent with user perception of interaction context preservation is validated and virtual reality (VR) is provided for selecting a recommended placement through visual guidance.
MR telepresence environment and analysis to assess the effectiveness of visual guidance and avatar placement method in a target application scenario

Hereinafter, previous studies (or technology) on a remote telepresence system and visualization in MR, which are main focuses of the present invention, will be described.

### Telepresence System

Early telepresence research developed methods for visualizing a remote user or a surrounding object in a local space using projection, display, and 3D capture technology. Existing technology 1 proposed a proof-of-concept telepresence system for realizing a real-time 3D scene capture and head-tracked stereo view using multiple RGB-d cameras and elaborated the system with a customized see-through head-worn display and a projector configured to merge a remote user's visual information into a user's local environment. Existing technology 2 introduced a system for inviting a remote user to a local physical destination. Remote visitors wear motion tracking suits and their movements are transmitted to animate avatars in a local space. Surround cameras in a local system capture an image of a local destination and send the captured image back to a remote space to be rendered in visitors' head mounted devices (HMDs). Existing technology 3 reconstructed virtual images of two remote groups of people from depth images to a shared virtual world with a projection-based method. Existing technology 4 proposed a novel concept of a cylindrical display configured to allow a user to correctly perceive a remote user's gaze direction and eye contact. Such non-verbal signals play an important role in face-to-face interaction but are frequently lost in a 2D planar display. As a real-time spatial capture and reconstruction became possible with a single HMD, researchers developed an end-to-end MR telepresence system for reconstructing volumetric meshes of remote objects and users in a local space. A straightforward capture-and-reconstruct approach does not consider dissimilarity between remote spaces, but the spatial dissimilarity makes it challenging to convey a user's intention correctly. Addressing this problem, researchers proposed a method of defining a valid area for interaction. Existing technology 5 optimized an alignment between two remote rooms to form a consensus space with maximum common features.

Another area of research focuses on avatar-mediated telepresence that enables a user embodiment, in contrast to an RGB-d replication-based system. In the avatar-mediated telepresence, a crucial aspect is determining an appropriate placement of a remote avatar to effectively convey a user's context to a partner in a remote space. Existing technology 6 introduced a heuristic scheme to determine an ideal placement of a remote avatar corresponding to a state in which a local user is seated or stands. Also, existing technology 7 developed a deep neural network trained with placement data obtained from a user experiment to compute a remote placement that best preserves a geometric relationship between a local user and a surrounding object. These studies still have limitations since they do not consider follow-up interpersonal and human-object interactions. On the other hand, the visual guidance proposed herein recommends a local placement according to a degree of preserving gaze and pointing context.

Several recent studies focused on various techniques to support MR-based remote collaboration. Existing technology 8 presented Mini-Me, a size-adjustable avatar that transforms its scale and orientation to adapt to a remote user's field of view (FOV) while maintaining a local user's gaze and gesture. Existing technology 9 proposed Loki, a bidirectional MR telepresence system with user interfaces of VR/AR view switching, 2D video, and hologram. Existing technology 10 provided a user with a panoramic representation of surroundings and rendered a current FOV and hands of a remote user. While these methods assume the use of a shared space or interaction in only one space, the present invention allows a user to simultaneously utilize two spaces. This is particularly important when considering a real-world space, which typically lacks a dedicated XR space and without furniture.

### Visualization in Mixed Reality

Giving visual cues for effective communication in MR has been researched from emergence of the technology. Early works focused on enhancing a user performance in a specific task by drawing a user's attention with simple visual cues and annotations. These studies increased the user's competence and proved the potential for MR visual cues. However, such a system does not explicitly consider remote collaboration in MR. 2D annotation is not suitable for an MR environment in which the user has a free access to both physical content and virtual content.

Since gaze and pointing are essential to understand user interaction context and accordingly, critical for immersive MR telepresence collaboration, many works focus on sharing information by providing visual cues. Existing technology 11 studied visualization of a remote helper's gaze and pointing in a local worker's live HMD view. Different conditions of visualizing a remote user's pointing and gaze to a local user building given structures with LEGO blocks were compared. The experiment showed that providing both cues helped users understand each other, significantly increasing the sense of co-presence. Existing technology 12 investigated an embodiment of avatar representation with the head and hands. In addition, that visualizing a virtual boundary of FOV enhances communication during MR collaboration was found. As follow-up research on the effect of visual cues, combinations of visual cues, including FOV frustum, eye-gaze ray, and head-gaze ray, were compared. Symmetric searching and asymmetric placing tasks of virtual blocks in a shared space of one physical (AR) and one virtual (VR) setup were designed. The mixture of the FoV frustum and the head-gaze ray was found to bring highest task performance and preference. Existing technology 13 implemented a 3D panorama-based MR collaboration system and conducted a user study to investigate the effect of adding hand gesture signals on context understanding and co-presence. That the combined cues of gaze and gesture deliver spatial actions significantly better than the gaze cue alone was experimentally proved. Despite observations on the effect of visualization in MR collaboration, these studies suppose the MR system for relocating a remote user to a local user's space.

Recent technical progress, such as spatial capture and real-time tracking, allowed researchers to introduce novel visualization methods for collaboration in a bidirectional MR environment. Several studies captured a remote space in real time and reconstructed the captured remote space as point clouds or 3D meshes in a local space. Existing technology 14 introduced a virtual arm of a remote expert as interactive guiding tool for a local user during a collaborative work. Existing technology 15 proposed a hands-free remote AR projection system including two cameras on a teleoperated robotic arm to stream a local worker's space. A remote helper views a physical space for effective communication. Existing technology 16 developed a hybrid system of 360 panorama video and reconstructed a 3D scene and compared two methods through a user study. Participants reported that panorama view is better for figuring out a partner's attention while the reconstructed scene is better for performing assigned tasks. While previous studies relate to visualizing a remote space itself and user interfaces allowing easy annotation and manipulation, the present invention focuses on modeling processed information of recommendation scores of local placements and visualizing the same to support clear communication between distant users.

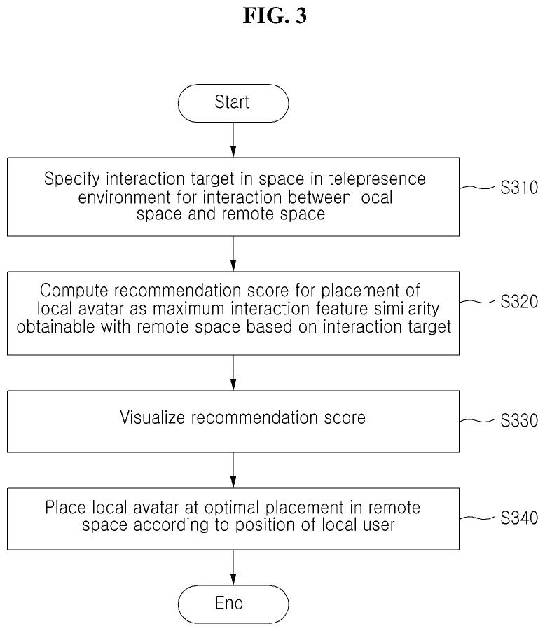

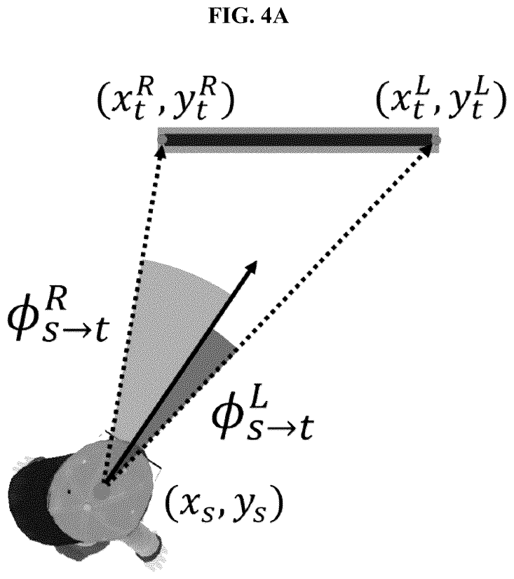

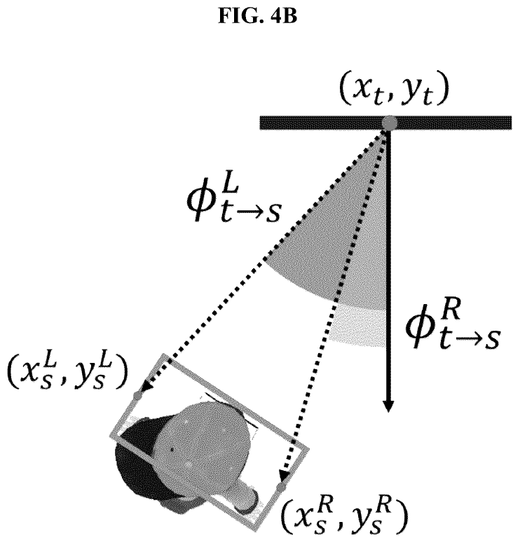

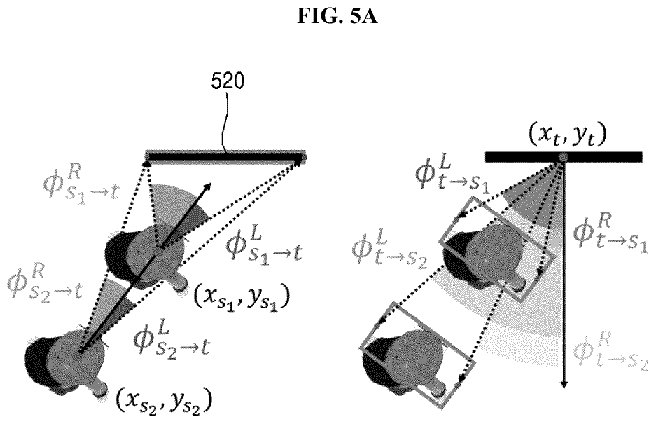

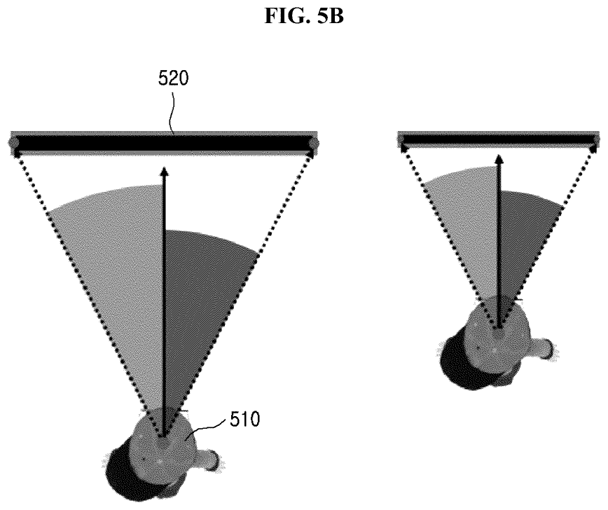

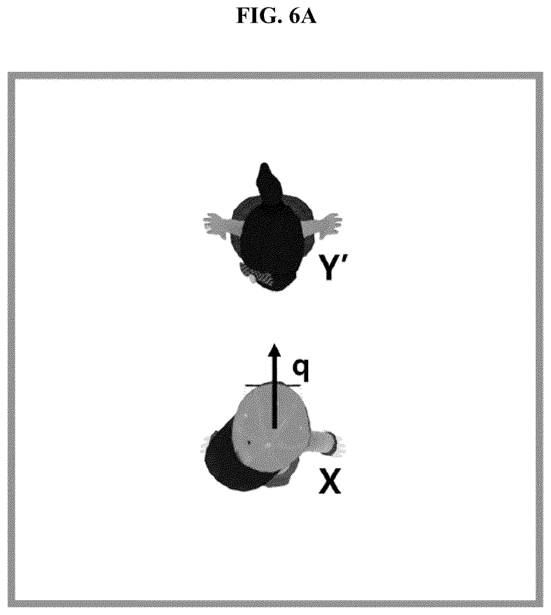

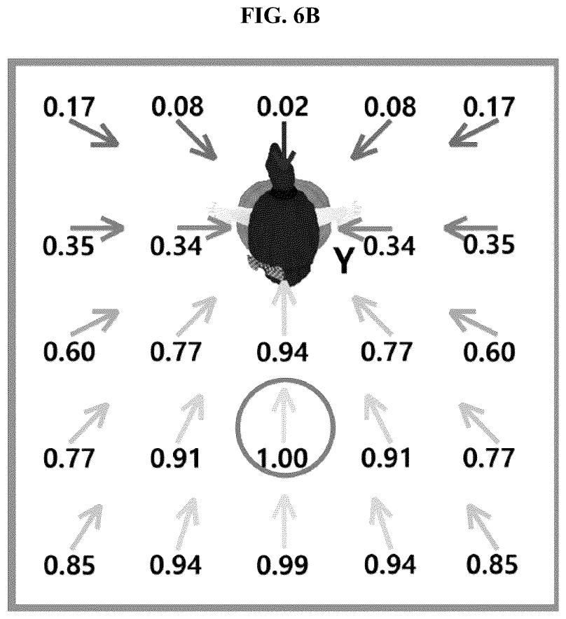

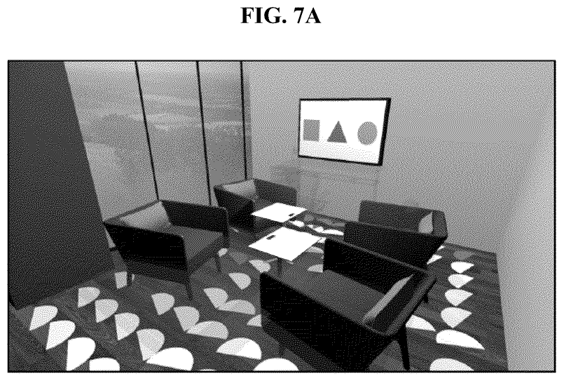

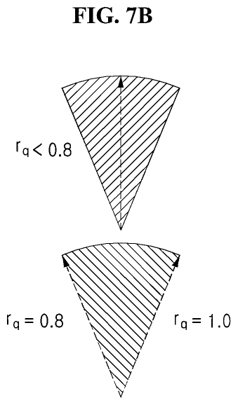

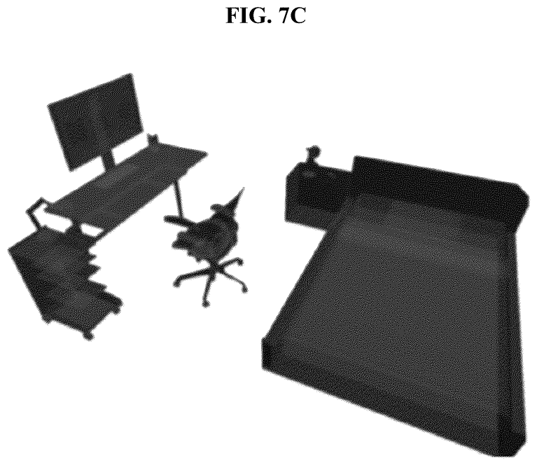

FIG. 3 is a flowchart illustrating a visual guidance method for user placement in an avatar-mediated telepresence environment according to an example embodiment. Also, FIGS. 4A and 4B illustrate four angles between a source object and a target object according to an example embodiment, and FIGS. 5A and 5B illustrate a feature according to a placement and a distance with an interaction target according to an example embodiment. Also, FIGS. 6A and 6B illustrate similarity of sample placement of an avatar according to an example embodiment, and FIGS. 7A, 7B and 7C illustrate overview of a visual guidance according to an example embodiment; and

The method of FIG. 3 is performed by a visual guidance system for user placement in an avatar-mediated telepresence environment according to an example embodiment.

The purpose of the present invention is to achieve a clear transfer of a user's interaction context to a corresponding avatar in a remote space. Since the present invention is used before the user executes a telepresence system, an interaction targets (target object for gaze and pointing) is manually set by user input. Then, the present invention computes and visualizes recommendation scores of local placements as shown in the left of FIGS. 1A and 1B. Visual guidance encourages the user to move to a better placement such that an avatar of the user may be located to preserve the user's interaction context for a selected target. For each sampled local placement for visual guidance, the present invention computes an optimal corresponding placement (optimal corresponding placement (OCP) for short), the corresponding remote placement that best preserves the interaction context of the local placement and the associated recommendation score. After the user arrives at a desired placement, the present invention places a remote avatar at its OCP. Images on the right of FIGS. 1A and 1B show the remote avatar placed at the OCP. The present invention relates to both interpersonal and human-object relationships and the screen and the other user's avatar may be selected as interaction targets.

Referring to FIG. 3, in operation S310, an interaction target in a space is specified in a telepresence environment for an interaction between a local space and a remote space. Operation S310 may specify an object selected by a local user and an interaction target of a person in the local space and may specify an object selected by a remote user and an interaction target of a person in the remote space. Here, the interaction target represents a target object for gaze and pointing and may be a person or an object. For example, the interaction target may be a TV (or screen) in FIGS. 1A, 1B and 2, and may be a TV and the user Y 120 in FIG. 1B.

In operation S320, a recommendation score for a placement of a local avatar may be computed as a maximum interaction feature similarity obtainable with the remote space based on the interaction target.

Operation S320 relates to computing an interaction feature that represents a spatial relationship between the local user and the screen (or TV) gazed by the local user and may compute the interaction feature using four angle attributes between the local user and the screen. Operation S320 may define similarity of interaction feature between the local user and a remote avatar as a quantitative measure for the degree of interaction context preserved.

Also, operation S320 may use feature similarity of a sampled placement of the local avatar in the remote space for a given placement of the local avatar in the local space by considering an interpersonal interaction between the local user and the remote avatar, and between the local avatar and the remote user. Therefore, operation S320 may compute the recommendation score with the maximum interaction feature similarity using a feasible placement in a continuous space in which the local avatar may be free from a collision with furniture, wall, or a person in the remote space.

Describing a process of operation S320 in more detail, the present invention may start with formulating a feature of a placement with respect to interaction context, which will be used as a measure for placing an avatar.

According to recent studies on collaborative virtual environment (CVE), an observer's viewpoint from a target affects accuracy of understanding the other user's gestures in a shared virtual space. Dissimilar to those works in the CVE, the present invention is designed for MR collaboration between two distant real spaces. However, the present invention still shares the goal of increasing the accuracy of interpreting gaze and gesture when a user is able to only observe the other user's avatar. To achieve the goal, it is assumed that a spatial relationship between the user and an interaction target of the local space needs to be preserved as much as possible for corresponding targets in the remote space.

To this end, the present invention defines an interaction feature Φ that represents a spatial relationship between a source object and a target object t as Equation 1.

$$Φ = [ {ϕ}_{s \to t}^{R} , {ϕ}_{s \to t}^{L} , {ϕ}_{t \to s}^{R} , {ϕ}_{t \to s}^{L} ] , \qquad [ Equation 1 ]$$

$$- π < ϕ \underline{<} π$$

Here, ϕ_{s→t}^{R} denotes an angle between a front direction of s and a right end of t. Given placements of a source and a target, qₛ=(xₛ,yₛ,θₛ) and qₜ=(xₜ,yₜ,θₜ), and their right/left endpoints, (xₛ^{R},yₛ^{R})/(xₛ^{L},yₛ^{L}) and (xₜ^{R},yₜ^{R})/(xₜ^{L},yₜ^{L}), the interaction feature is computed as Equation 2.

$$Φ = [ a tan 2 ( {y}_{t}^{R} - {y}_{s} , {x}_{t}^{R} - {x}_{s} ) - {θ}_{s} , a tan 2 ( {y}_{t}^{L} - {y}_{s} , {x}_{t}^{L} — {x}_{s} ) - {θ}_{s} a tan 2 ( {y}_{s}^{R} - {y}_{t} , {x}_{s}^{R} - {x}_{t} ) - {θ}_{t} , a tan 2 ( {y}_{s}^{L} - {y}_{t} , {x}_{s}^{L} , - {x}_{t} ) - {θ}_{t} ] \qquad [ Equation 2 ]$$

FIGS. 4A and 4B illustrate an example of an interaction feature between a user and a TV (screen). An angle from t to s is also considered to maintain a direction from t to s.

By using four angle attributes between two objects, a user 510 and a TV 520, an interaction feature implicitly explains a distance between the two objects as well as the direction. For example, in FIG. 5A, s₁ and s₂ are in the same direction from t, interaction features Φ1 and Φ2 are different. ϕₛ_{₁}_{→t}^{R}, ϕₛ_{₁}_{→t}^{L}, and ϕ_{t→s}_{₁}^{R} are larger than ϕₛ_{₂}_{→t}^{R}, ϕₛ_{₂}_{→t}^{L}, and ϕ_{t→s}_{₂}^{L}, respectively, and ϕ_{t→s}_{₁}^{R} is smaller than ϕ_{t→s}_{₂}^{R}. Since the interaction feature is defined only using angles without using distance, preserving interaction features for targets with different sizes in two distant spaces indicates that the TV 520 corresponding to the interaction target has the same position and size in egocentric visions of the user 510 and the avatar as shown in FIG. 5B.

A feature vector of interaction between a source and n interaction targets is defined as a concatenation of interaction features for each target Φ=[Φᵢ]ᵢ₌₁ⁿ.

As an avatar mirrors a user motion, it is assumed that sharing the same interaction feature between a local user and a remote avatar allows effective remote communication. A remote user may fully understand the local user's intention on targets (interaction context) only by observing a behavior of the local user's avatar. Therefore, an interaction feature similarity between the local user and the remote avatar is defined as a quantitative measure for the degree of interaction context preserved.

Given local placement q=(x, y, θ) and remote placement q′=(x′, y′, θ′), the interaction feature similarity is defined as a Gaussian kernel distance.

$$S ( {Φ}_{q} , {Φ}_{{q}^{′}} ) = {e}^{- 2 {‖ {Φ}_{q} - Φ {q}^{′} ‖}^{2}} \qquad [ Equation 3 ]$$

FIGS. 6A and 6B illustrate feature similarities of sampled placements of a local user's local avatar X′ in a remote space for a given X placement in a local space, considering an interpersonal interaction (X-Y′ and X′-Y). In FIG. 6B, the identical placement of the avatar in the remote space (marked with a circle) has a highest similarity of 1.0 and the similarity gradually decreases as the placement deviates in angle or distance from the identity.

Due to a spatial discrepancy in MR telepresence, it is impossible to have an identical interaction feature for local and remote placements in many cases. Therefore, the present invention recommends a local placement that has a certain degree of interaction context preservation, measured as an interaction feature similarity or more.

For a candidate placement q, operation S320 computes its recommendation score r_{q} as a maximum interaction feature similarity obtainable from the remote space.

$${r}_{q} = {max}_{{q}^{′} ∈ {\hat{Q}}^{′}} S ( {Φ}_{q} , {Φ}_{{q}^{′}} ) \qquad [ Equation 4 ]$$

Here, q′ denotes a placement in a continuous space of feasible placement \hat{Q}′ in the remote space. Here, the feasible placement refers to a placement in which an avatar may exist naturally, free from a collision with furniture or wall.

The remote placement, q′, having a highest feature similarity for given local placement q is defined as OCP of q, denoted as q*=(x*, y*, θ*).

To find OCP q* as a feasible placement, not only its interaction feature similarity but also its feasibility to accommodate the avatar is considered. To this end, collision cost and out-of-space cost are added to an objective function, Equation 4.

The collision cost is designed to avoid a collision between an avatar and an object. The function is defined as a multivariate Gaussian function with mean p_{obj}′ at the center of the object and standard deviation determined by the object's width ω_{obj}′, length l_{obj}′, and orientation θ_{obj}′.

$${C}_{col , {q}^{′}} = {e}^{- \frac{1}{2} {[ {p}^{′} - {p}_{obj}^{′} ]}^{T} {\sum }^{- 1} {[ {p}^{′} - {p}_{obj}^{′} ]}^{T}} \qquad [ Equation 5 ]$$

$$\sum = R Λ {R}^{T}$$

$$R = [ \begin{matrix}cos ( {θ}_{obj}^{′} ) & - sin ( {θ}_{obj}^{′} ) \\ sin ( {θ}_{obj}^{′} ) & cos ( {θ}_{obj}^{′} )\end{matrix} ] ,$$

$$Λ = [ \begin{matrix}{( \frac{{ω}_{obj}^{′}}{2} )}^{2} & 0 \\ 0 & {( \frac{{I}_{obj}^{′}}{2} )}^{2}\end{matrix} ]$$

To limit the OCP inside the remote space during optimization, the out-of-space cost defined as an exponential “cliff” function is designed along four borders of the space floor. Here, x_{c}′ and y_{c}′ denote center coordinates of the space, and ω′ and l′ denote a width and a length of the space.

$${C}_{out , {q}^{′}} = 3 ( {e}^{\frac{2}{{ω}^{′}} \cdot ( \vert {x}^{′} - {x}_{c}^{′} \vert - \frac{{ω}^{′}}{2} )} + {e}^{\frac{2}{{l}^{′}} \cdot ( \vert {y}^{′} - {y}_{c}^{′} \vert - \frac{{l}^{′}}{2} )} ) \qquad [ Equation 6 ]$$

The OCP q* is obtained through a steepest descent algorithm that iteratively updates the remote placement q′ with gradient ∇C computed according to the condition of q′.

$${q}_{i}^{′} ← {q}_{i}^{′} + γ ∇ C \qquad [ Equation 7 ]$$

$$∇ C = \{ \begin{matrix}- \frac{{dC}_{col , {q}^{′}}}{{dq}^{′}} & if {q}^{′} in collision , \\ - \frac{{dC}_{out , {q}^{′}}}{{dq}^{′}} & if {q}^{′} out of space , \\ \frac{dS}{{dq}^{′}} & otherwise .\end{matrix}$$

It is determined that q′ is in collision if q′ intersects a predefined bounding box of the object and q′ is out of space if q′ lies outside the bounding box of the floor.

For experiments, the present invention set a step size las γ=[γ_{x′}, γ_{y′}, γ_{θ′}] as [0.1, 0.1, 1.0]. After obtaining q*, feature similarity S(Φ_{q}, Φ_{q*}) was set as recommendation score r_{q}=S(Φ_{q}, Φ_{q*}) of a candidate local space placement q.

Also, for computational feasibility, operation S320 discretizes the local space into n sample placements and computes recommendation scores. Operations S320 initially generates a set Q of local placement samples by grid-sampling the space with distance and angle intervals (0.33 m and

$$\frac{π}{4}$$

for the experiments) to obtain Q={qᵢ}ᵢ₌₁ⁿ, qᵢ=(pᵢ, θᵢ), pᵢ=(xᵢ, yᵢ). According to existing research materials (Strasburger's report) on a horizontal span of human vision, the present invention set visibility constraint as a horizontal range of

$$\pm \frac{π}{2}$$

from an egocentric viewpoint. Among samples in Q, only qᵢ is included in a candidate sample set Q⁺ only if a source, qᵢ, and a target are mutually visible (i.e., all the absolute values of angle differences between a source angle and angles of vectors from a source position to a target position are smaller than

$$\frac{π}{2}$$

). For every element qᵢ∈Q⁺, an OCP in the remote space and a corresponding recommendation score are computed.

Referring again to FIG. 3, in operation S330, the recommendation score is visualized.

Operation S330 may visualize recommendation scores with color-coded sectors on the floor in the local space. In detail, operation S330 may visualize a recommendation score with a red color-coded sector if the recommendation score is less than a threshold and may visualize recommendation scores with yellow to green color-coded sectors if the recommendation score corresponds to an in-between score. Here, operation S330 uses a 2D color sector to visualize scores to the user.

Operation S330 may visually provide a virtual object of an interaction target specified in the remote space to the local space. The virtual object of the interaction target specified in the remote space is overlapped on the local space to provide a hint of a remote space layout. A main goal of visual guidance is to influence the user to select a better local placement such that the avatar placed at the OCP may effectively deliver the user's interaction context to the other user. In practice, when the interaction target is specified by user input (operation S310), the present invention provides the visual guidance. Given information, the user may freely move to the selected placement for interaction and may place the remote avatar at OCP.

FIG. 7B show images of 2D sectors in a top view. Each placement q=(x, y, θ)∈Q⁺ is represented as a 2D cone with a central angle set to a sampling interval (

$$\frac{π}{4}$$

for experiments), located at (x, y) with a direction of θ. If a recommendation score, r_{q}, is less than a threshold (0.8), the entire cone is colored red to inform the user that the placement is inappropriate for interaction with an assigned target. Here, the threshold may be found through a user experiment. Recommendation scores of 0.8 and 1.0 correspond to yellow and green, colors of in-between scores are linearly interpolated in HSV color space. Since eight orientations are sampled for each position, scores of in-between directions are estimated by linearly interpolating scores of two adjacent samples.

Only with sectors that visualize recommendation scores of placements, the user may not understand why a specific placement is inappropriate for interaction. Therefore, to make the visual guidance more informative, operation S330 shows a virtual object of a remote space object in the local space. FIG. 7C shows an image of a transparent virtual object (or remote model). For example, if the local user selects a local object as an interaction target in space A, a 3D virtual object of a remote corresponding object is overlapped with respect to a coordinate frame of a primary target (interaction target in space A). Depending on example embodiments, for multiple interaction targets, operation S330 sets a screen as the primary target.

Visualizing the remote model to the virtual object allows the user to verify the identical placement in the remote space, and brings an additional benefit of helping the user selects a placement that give better visibility for the remote avatar on the remote interaction target.

Since some 2D sectors may be occluded by real furniture and objects, the user may not view recommendations for the entire placements. Such partial observation may restrict movement of the user only within a visible area. To prevent such bias, operation S330 provides a top view of the local space to be optionally viewed with the visual guidance. Here, the top view may be enabled/disabled by user input.

In operation S340, when the local user is located in a corresponding sector, the local avatar is placed at an optimal placement within the remote space according to a position of the local user. When the local user is located in a specific sector among visualized sectors through operation S330, operation S340 may receive the position of the local user as input and may output and place a movement of the local avatar such that the local avatar in the remote space may be located at the same position as the local user.

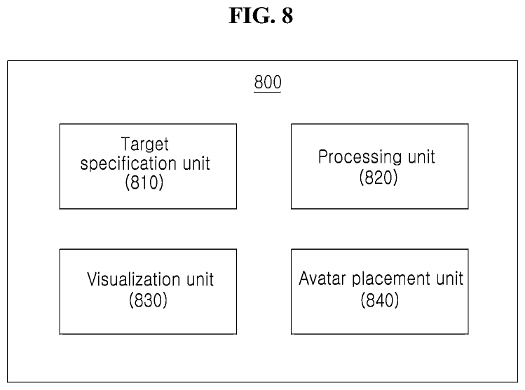

Here, operation S340 according to an example embodiment focuses on preserving the local user's interaction context for placement of the local avatar. Here, the interaction context represents a behavior of the user with respect to a target object with which the user interacts. FIG. 8 is a block diagram illustrating a configuration of a visual guidance system for user placement in an avatar-mediated telepresence environment according to an example embodiment.

The visual guidance system for user placement in the avatar-mediated telepresence environment of FIG. 8 may direct a user to an optimal placement that facilitates the clear transfer of gaze and pointing context through a remote avatar in dissimilar spaces in which a spatial relationship between a remote avatar and an interaction target may differ from that of a local user.

To this end, a visual guidance system 800 for user placement in an avatar-mediated telepresence environment includes a target specification unit 810, a processing unit 820, a visualization unit 830, and an avatar placement unit 840.

The target specification unit 810 specifies an interaction target in a space in a telepresence environment for an interaction between a local space and a remote space. The target specification unit 810 may specify an object selected by a local user and an interaction target of a person in the local space and may specify an object selected by a remote user and an interaction target of a person in the remote space. Here, the interaction target represents a target object for gaze and pointing and may be a person or an object. For example, the interaction target may be a TV (or screen) in FIGS. 1A, 1B and 2 and may be a TV and the user Y 120 in FIG. 1B.

The processing unit 820 computes a recommendation score for a placement of a local avatar as a maximum interaction feature similarity obtainable with the remote space based on the interaction target.

The processing unit 820 relates to computing an interaction feature that represents a spatial relationship between the local user and the screen (or TV) gazed by the local user and may compute the interaction feature using four angle attributes between the local user and the screen. The processing unit 820 may define similarity of interaction feature between the local user and a remote avatar as a quantitative measure for the degree of interaction context preserved.

Also, the processing unit 820 may use feature similarity of a sampled placement of the local avatar in the remote space for a given placement of the local avatar in the local space by considering an interpersonal interaction between the local user and the remote avatar, and between the local avatar and the remote user. Therefore, the processing unit 820 may compute the recommendation score with the maximum interaction feature similarity using a feasible placement in a continuous space in which the local avatar may be free from a collision with furniture, wall, or a person in the remote space.

The visualization unit 830 visualizes the recommendation score.

The visualization unit 830 may visualize recommendation scores with color-coded sectors on the floor in the local space. In detail, the visualization unit 830 may visualize a recommendation score with a red color-coded sector if the recommendation score is less than a threshold and may visualize recommendation scores with yellow to green color-coded sectors if the recommendation score corresponds to an in-between score. Here, the visualization unit 830 uses a 2D color sector to visualize scores to the user.

When the local user is located in a corresponding sector, the avatar placement unit 840 places the local avatar at an optimal placement within the remote space according to a position of the local user. When the local user is located in a specific sector among visualized sectors through the visualization unit 830, the avatar placement unit 840 may receive the position of the local user as input and may output and place a movement of the local avatar such that the local avatar in the remote space may be located at the same position as the local user.

Here, the avatar placement unit 840 according to an example embodiment focuses on preserving the local user's interaction context for placement of the local avatar. Here, the interaction context represents a behavior of a user with respect to a target object with which the user interacts.

Although description is omitted in the system of FIG. 8, it will be apparent to those skilled in the art that each component constituting FIG. 8 may include all the contents described above with reference to FIGS. 1 to 7.

The systems or the apparatuses described herein may be implemented using hardware components, software components, and/or combinations of hardware components and software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be permanently or temporarily embodied in any type of machine, component, physical equipment, virtual equipment, a computer storage medium or device, or a signal wave to be transmitted, to be interpreted by the processing device or to provide an instruction or data to the processing device. The software also may be distributed over network coupled computer systems so that the software is stored and executed in a distributed fashion. The software and data may be stored by one or more computer readable storage media.

The methods according to the above-described example embodiments may be configured in a form of program instructions performed through various computer devices and recorded in computer-readable media. The media may include, alone or in combination with the program instructions, data files and data structures. The program instructions stored in the media may be specially designed and configured for the example embodiments or may be those known to those skilled in the computer software art and thereby available. Examples of the media include magnetic media such as hard disks, floppy disks, and magnetic tapes; optical media such as CD-ROM and DVDs; magneto-optical media such as floptical disks; and hardware devices that are specially configured to store program instructions, such as read-only memory (ROM), random access memory (RAM), flash memory, and the like. Examples of the program instructions include a machine language code produced by a compiler and an advanced language code executable by a computer using an interpreter. The hardware device may be configured to operate as at least one software module to perform an operation of the example embodiments, or vice versa.

While the example embodiments are described with reference to specific example embodiments and drawings, it will be apparent to one of ordinary skill in the art that various changes and modifications in form and details may be made in these example embodiments from the description. For example, suitable results may be achieved if the described techniques are performed in a different order, and/or if components in a described system, architecture, device, or circuit are combined in a different manner, or replaced or supplemented by other components or their equivalents.

Therefore, other implementations, other example embodiments, and equivalents of the claims are to be construed as being included in the claims.

What is claimed is:

1. A visual guidance method for user placement in an avatar-mediated telepresence environment, the visual guidance method comprising:
specifying an interaction target in a space in a telepresence environment for an interaction between a local space and a remote space;
computing a recommendation score for a placement of a local avatar as a maximum interaction feature similarity obtainable with the remote space based on the interaction target;
visualizing the recommendation score; and
placing the local avatar at an optimal placement in the remote space according to a position of a local user.

2. The visual guidance method of claim 1, wherein the specifying comprises specifying an object selected by the local user and an interaction target of a person in the local space and specifying an object selected by a remote user and an interaction target of a person in the remote space.

3. The visual guidance method of claim 1, wherein the computing comprises computing an interaction feature that represents a spatial relationship between the local user and a screen gazed by the local user, and computing the interaction feature using four angle attributes between the local user and the screen.

4. The visual guidance method of claim 3, wherein the computing comprises defining a similarity of interaction feature between the local user and a remote avatar as a quantitative measure for the degree of interaction context preserved.

5. The visual guidance method of claim 1, wherein the computing comprises using a feature similarity of a sampled placement of the local avatar in the remote space for a given placement of the local avatar in the local space by considering an interpersonal interaction between the local user and the remote avatar, and between the local avatar and the remote user.

6. The visual guidance method of claim 5, wherein the computing comprises computing the recommendation score with the maximum interaction feature similarity using a feasible placement in a continuous space in which the local avatar is free from a collision with furniture, wall, or a person in the remote space.

7. The visual guidance method of claim 1, wherein the visualizing comprises visualizing the recommendation score with a color-coded sector on the floor in the local space.

8. The visual guidance method of claim 7, wherein the visualizing comprises visually providing a virtual object of the interaction target specified in the remote space to the local space.

9. The visual guidance method of claim 1, wherein the placing comprises placing the local avatar at an optimal placement for preserving interaction context in the remote space when the local user is located in a specific sector among sectors coded on the floor in the local space, and
interaction context represents a behavior of a user with respect to a target object with which the user interacts.

10. A visual guidance system for user placement in an avatar-mediated telepresence environment, the visual guidance system comprising:
a target specification unit configured to specify an interaction target in a space in a telepresence environment for an interaction between a local space and a remote space;
a processing unit configured to compute a recommendation score for a placement of a local avatar as a maximum interaction feature similarity obtainable with the remote space based on the interaction target;
a visualization unit configured to visualize the recommendation score; and
an avatar placement unit configured to place the local avatar at an optimal placement within the remote space according to a position of a local user.
